(19) United States
(12) Patent Application Publication
(10) Pub. No.: US 2020/0182217 A1
(43) Pub. Date: Jun. 11, 2020

(54) COMBUSTION IGNITION DEVICES FOR AN INTERNAL COMBUSTION ENGINE

(71) Applicant: GM GLOBAL TECHNOLOGY OPERATIONS LLC, DETROIT, MI (US)

(72) Inventors: SeungHwan Keum, Northville, MI (US); Cherian A. Idicheria, Novi, MI (US); Paul M. Najt, Bloomfield Hills, MI (US)

(21) Appl. No.: 16/214,408

(22) Filed: Dec. 10, 2018

(51) Int. Cl. F02P 23/04; F02B 19/10; H05H 1/24

(52) U.S. Cl. CPC F02P 23/04; H05H 1/2406; F02B 19/1004; F02B 19/108

(57) ABSTRACT

An internal combustion engine includes a combustion chamber formed by cooperation of a cylinder bore formed in a cylinder block, a cylinder head and a piston. A combustion ignition device is disposed in the combustion chamber and includes a nozzle defining a pre-chamber, a barrier discharge plasma igniter, including a tip portion disposed in the pre-chamber and a plurality of apertures disposed in the nozzle. The pre-chamber is in fluidic communication with the combustion chamber via the plurality of apertures. A controller is in communication with the engine and the barrier discharge plasma igniter.

### INTRODUCTION

Spark-ignition (SI) engines introduce an air/fuel mixture into each cylinder that is compressed during a compression stroke and ignited by a spark plug. SI engines may operate in different combustion modes, including, by way of non-limiting examples, a homogeneous SI combustion mode and a stratified-charge SI combustion mode. SI engines may be configured to operate in a homogeneous-charge compression-ignition (HCCI) combustion mode, also referred to as controlled auto-ignition combustion, under predetermined speed/load operating conditions. HCCI combustion is a distributed, flameless, kinetically-controlled auto-ignition combustion process with the engine operating at a dilute air/fuel mixture, i.e., lean of a stoichiometric air/fuel point, with relatively low peak combustion temperatures, resulting in low NOx emissions.

### SUMMARY

Provided are combustion ignition devices disposed in a combustion chamber of an internal combustion engine. The combustion ignition devices include a pre-chamber shell having an inner surface defining a pre-chamber and one or more apertures establishing fluidic communication between the pre-chamber and the combustion chamber, a barrier-discharge plasma igniter, including a tip portion disposed in the pre-chamber, and one or more plasma propagating features extending from the pre-chamber shell inner surface into the pre-chamber. The one or more plasma propagating features can include a refractory metal. The one or more plasma propagating features can be a cone or wedge shape. The pre-chamber shell can be a copper alloy, an aluminum alloy, or a refractory metal. The barrier-discharge plasma igniter can include an electrode including a tip portion that is encapsulated in a dielectric material. The one or more plasma propagating features can be biased towards the tip portion of the barrier-discharge plasma igniter. The one or more plasma propagating features can have a surface roughness of up to about 150 micrometers. The one or more plasma propagating features can include a plurality of plasma propagating features. The one or more plasma propagating features can extend inward from the inner surface of the pre-chamber shell by up to about 7 millimeters. The combustion ignition device can further include a pre-chamber fuel injector including a tip portion disposed in the pre-chamber and a pre-chamber air injector including a tip portion disposed in the pre-chamber.

Also provided are internal combustion engines, which can include a cylinder bore, a cylinder head and a piston cooperating to form a combustion chamber, a fuel injector disposed to inject fuel to the combustion chamber, and a combustion ignition device disposed in the combustion chamber. The combustion ignition device can include a pre-chamber shell having an inner surface defining a pre-chamber and one or more apertures establishing fluidic communication between the pre-chamber and the combustion chamber, and a barrier-discharge plasma igniter, including a tip portion disposed in the pre-chamber. The one or more plasma propagating features can include a refractory metal. The one or more plasma propagating features can be a cone or wedge shape. The pre-chamber shell can be a copper alloy or an aluminum alloy. The barrier-discharge plasma igniter can include an electrode including a tip portion that is encapsulated in a dielectric material. The one or more plasma propagating features can be biased towards the tip portion of the barrier-discharge plasma igniter. The one or more plasma propagating features can have a surface roughness of up to about 150 micrometers. The one or more plasma propagating features can include a plurality of plasma propagating features. The one or more plasma propagating features can extend inward from the inner surface of the pre-chamber shell by up to about 7 millimeters. The internal combustion engine can further include a pre-chamber fuel injector including a tip portion disposed in the pre-chamber and a pre-chamber air injector including a tip portion disposed in the pre-chamber.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a schematic cross-sectional view of a single cylinder for a multi-cylinder internal combustion engine and an associated engine controller, according to one or more embodiments; and

FIG. 2 illustrates a schematic cross-sectional side view of a combustion ignition device, according to one or more embodiments.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material in the related art has not been described in detail in order to avoid unnecessarily obscuring the disclosure. Furthermore, the drawings are in simplified form and are not to precise scale. For purposes of convenience and clarity, directional terms may be used with respect to the drawings. These and similar directional terms are not to be construed to limit the scope of the disclosure. Furthermore, the disclosure, as illustrated and described herein, may be practiced in the absence of an element which is not specifically disclosed herein.

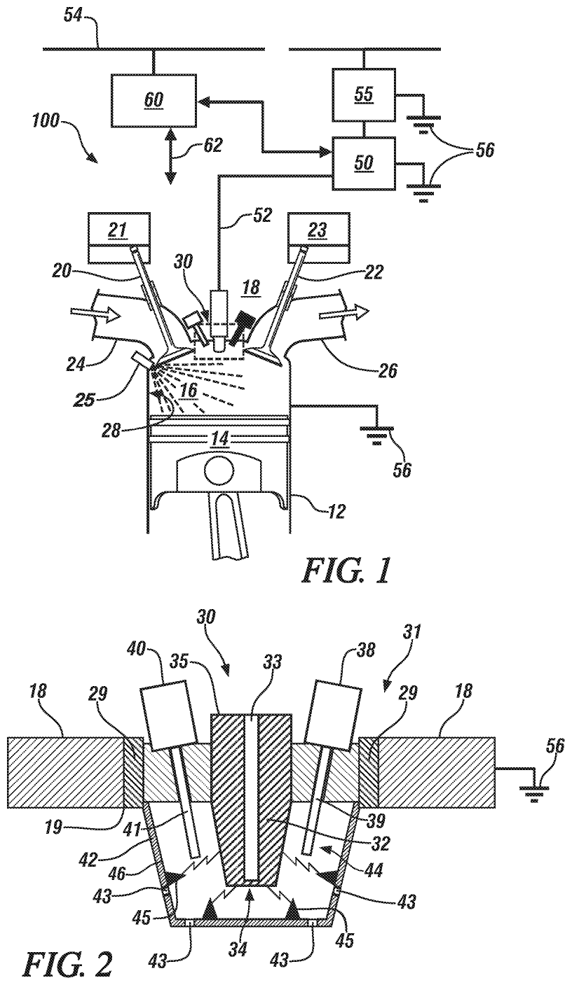

Referring now to the drawings, wherein the depictions are for the purpose of illustrating certain exemplary embodiments and not for the purpose of limiting the same, FIG. 1 illustrates a schematic cross-sectional view of a single cylinder for a multi-cylinder internal combustion engine (engine) 100 and an associated engine controller (ECM) 60. The engine 100 includes an engine block 12 defining a plurality of cylinder bores 28 containing movable pistons 14, one of which is shown. A cylinder head 18 is disposed on a nominal top portion of the engine block 12 and a rotating crankshaft (not shown) is disposed at a nominal bottom portion of the engine block 12. Each of the cylinder bores 28 houses one of the movable pistons 14. The walls of the cylinder bore 28, a top portion of the piston 14 and an inner exposed portion of the cylinder head 18 define outer boundaries of a variable-volume combustion chamber 16 that is disposed therein. Each piston 14 mechanically couples to a connecting rod that rotatably couples to the crankshaft, and the piston 14 slidably translates within the cylinder bore 28 in reciprocating motion between a top-dead-center (TDC) position and a bottom-dead-center (BDC) position to transfer mechanical power to the crankshaft during each combustion cycle. The engine 100 preferably operates in a four-stroke combustion cycle that includes repetitively executed intake, compression, expansion and exhaust strokes, wherein the strokes are associated with translation of the piston 14 with the cylinder bore 28. Operation of the engine 100 is controlled by the ECM 60, which communicates with a fuel injection system to control a fuel injector 25 to inject fuel, and communicates with a plasma ignition controller 50 via line 62 to control operation of a combustion ignition device 30 that includes a dielectric barrier-discharge plasma igniter (plasma igniter) 31 (see FIG. 2) that is partially disposed in-cylinder. In one embodiment, the plasma igniter 31 is configured as a groundless dielectric barrier-discharge plasma igniter, although the concepts described herein are not so limited. As used herein, the term “groundless” indicates absence of a discrete element or structure proximal to the plasma igniter 31 that would be capable of electrically coupling to an electrical ground path. Details of the combustion ignition device 30 are shown with reference to FIG. 2. The combustion ignition device 30 including an embodiment of the plasma igniter described herein is preferably employed as a substitute for a spark ignition module and spark plug, and facilitate operation at lean air/fuel ratios, including operation in HCCI and other combustion modes.

The cylinder head 18 includes an intake port or runner 24 that is in fluid communication with the combustion chamber 16, with an intake valve 20 disposed within for controlling airflow into the combustion chamber 16. The cylinder head 18 also includes an exhaust port or runner 26 that is in fluid communication with the combustion chamber 16, with an exhaust valve 22 disposed within for controlling exhaust gas flow out of the combustion chamber 16. FIG. 1 shows a single intake valve 20 and a single exhaust valve 22 associated with the combustion chamber 16, but it is appreciated that each combustion chamber 16 may be configured with multiple intake valves and/or multiple exhaust valves. Engine airflow may be controlled by selectively adjusting position of a throttle valve (not shown) and adjusting openings and/or closings of the intake valves 20 and the exhaust valves 22 in relation to piston positions. An intake variable valve actuation system 21 is arranged to control openings and closings of the intake valves 20, and an exhaust variable valve actuation system 23 is arranged to control openings and closings of the exhaust valves 22. The intake and exhaust variable valve actuation systems 21, 23 may include variable cam phasing and a selectable multi-step valve lift, e.g., multiple-step cam lobes that provide two or more valve lift positions, and employ urgings of valve springs and lobes on one or more rotating camshafts that are rotatably coupled to the crankshaft, or other suitable mechanisms to effect such control. The change in valve position of the multi-step valve lift mechanism may be a discrete step change.

The cylinder head 18 may be arranged to provide structure for mounting fuel injectors 25, a single one of which is shown. Each fuel injector 25 is disposed to inject fuel into one of the combustion chambers 16. In one embodiment, the fuel injector 25 is arranged with a fuel combustion pre-chamber that is disposed in a geometrically central portion of a cylindrical cross-section of the combustion chamber 16 and aligned with a longitudinal axis thereof. The fuel injector 25 fluidly and operatively couples to a fuel injection system, which supplies pressurized fuel at a flowrate that is suitable to operate the engine 100. The fuel injector 25 includes a flow control valve and a fuel combustion pre-chamber that is disposed to inject fuel into the combustion chamber 16. The fuel may be a suitable composition such as, but not limited to, gasoline, ethanol, diesel, natural gas, and combinations thereof. The fuel combustion pre-chamber may extend through the cylinder head 18 into the combustion chamber 16. Furthermore, the cylinder head 18 may be arranged with the fuel injector 25 and fuel combustion pre-chamber disposed in a geometrically central portion of a cylindrical cross-section of the combustion chamber 16 and aligned with a longitudinal axis thereof. The fuel combustion pre-chamber may be arranged in line with the combustion ignition device 30 between the intake valve 20 and the exhaust valve 22. Alternatively, the cylinder head 18 may be arranged with the fuel combustion pre-chamber disposed in line with the combustion ignition device 30 and orthogonal to a line between the intake valve 20 and the exhaust valve 22. Alternatively, the cylinder head 18 may be arranged with the fuel combustion pre-chamber disposed in a side injection configuration. Alternatively, the fuel injector 25 may be arranged in a port fuel injection configuration, wherein a fuel combustion pre-chamber is disposed in the intake runner 24. The arrangements of the cylinder head 18 including the fuel combustion pre-chamber and the combustion ignition device 30 described herein are illustrative. Other suitable arrangements may be employed within the scope of this disclosure.

FIG. 2 illustrates a schematic cross-sectional side view of one embodiment of the combustion ignition device 30, which includes a pre-chamber shell 42 having an inner surface 46 defining a pre-chamber 44, and the plasma igniter 31 including tip portion 34 that is disposed within a pre-chamber 44. The cylinder head 18 may be arranged to provide structure for mounting the combustion ignition device 30, preferably in the form of a pass-through aperture 19. The cylinder head 18 electrically connects to an electrical ground 56. The plasma igniter 31 can be fixedly attached to a mounting boss 29 or another suitable structure. The mounting boss 29 preferably inserts through and attaches to the pass-through aperture 19 in the cylinder head 18 such that the pre-chamber 44 protrudes into the combustion chamber 16. A first end 35 of the electrode 33 can electrically connect to the plasma ignition controller 50.

The pre-chamber shell 42 includes one or more apertures 43 which establish fluidic communication between the pre-chamber 44 and the combustion chamber 16. For example, the nozzle body can comprise between three and ten apertures 43. In one embodiment, there can be between three and ten apertures 43, each with an average diameter of about 320 microns. The apertures 43 can be disposed about a center-line axis of the cylinder bore 28 at generally equally-spaced angles, for example between 60 degrees and 160 degrees from the centerline axis of the cylinder bore 28.

Each plasma igniter 31 includes at least one electrode 33 having a tip portion 34 that protrudes into the pre-chamber 44. The electrode 33 and tip portion 34 can be encapsulated in a dielectric coating 32. In one embodiment, the dielectric coating 32 can have a thickness of about 1 mm to about 5 mm. The dielectric coating 32 provides a dielectric barrier around the tip portion 34 of the electrode 33. As such, the tip portion 34 of the electrode 33 is fully encapsulated by the dielectric material that forms the dielectric coating 32. The dielectric coating 32 can be configured in a frustoconical shape that tapers in a narrowing fashion towards the tip portion 34, although one of skill in the art will recognize that other geometric configurations are practicable and the electrode 33 and dielectric coating 32 may be otherwise shaped and/or contoured relative to the contour of the tip portion 34. For example, the tip portion 34 may be shaped, for example, as a conical end, a cylindrical end, a chamfered cylindrical end, etc. Other cross-sectional shapes, e.g., oval, rectangular, hexagonal, etc., may be employed. Other configurations of dielectric barrier-discharge plasma igniters may be employed with similar effect. The dielectric material may be a suitable dielectric material capable of withstanding the temperatures and pressures that can occur in an engine combustion chamber. For example, the dielectric material may be a glass, quartz, or ceramic dielectric material, such as a high purity alumina.

The pre-chamber 44 is fed by the fuel, air and combustion products contained in the combustion chamber 16. In one embodiment, the combustion ignition device 30 also further includes a pre-chamber air injector 40 including a tip portion 41 disposed in the pre-chamber. In one embodiment, the combustion ignition device 30 also includes a pre-chamber fuel injector 38 including a tip portion 39 disposed in the pre-chamber. In one embodiment, the combustion ignition device 30 also includes a pre-chamber air injector 40 and a pre-chamber fuel injector 38. The pre-chamber fuel injector 38 may be a suitable fuel injection device that is capable of controllably delivering fuel into the pre-chamber 44 while withstanding the in-cylinder temperature and pressure environment. The pre-chamber air injector 40 may be a suitable air injection device that is capable of delivering air into the pre-chamber 44 while withstanding the in-cylinder temperature and pressure environment.

The plasma ignition controller 50 controls operation of the plasma igniter 31, employing electric power supplied from a power source 55, e.g., a DC power source. The plasma ignition controller 50 also electrically connects to the electrical ground path 56, thus forming an electrical ground connection to the cylinder head 18. The plasma ignition controller 50 electrically connects to each of the plasma igniters 31, preferably via a plurality of electrical cables 52, a single one of which is shown. The plasma ignition controller 50 includes control circuitry that is configured to generate a high-frequency, high-voltage electrical pulse that is supplied to each plasma igniter 31 via the electric cable 52 to generate a plasma discharge event that ignites fuel-air cylinder charges in response to control signals that may originate from the ECM 60. A current sensor may be disposed to monitor the electric cable 52 to detect electrical current that is supplied from the plasma ignition controller 50 to the plasma igniter 31 during each plasma discharge event. The current sensor may employ direct or indirect current sensing technologies in conjunction with signal processing circuits and algorithms to determine a parameter that is associated with the magnitude of current that is supplied to each plasma igniter 31. Such current sensing technologies may include, by way of non-limiting embodiments, induction, resistive shunt, or Hall effect sensing technologies.

The combustion ignition device 30 further comprises one or more plasma propagating features 45 extending from the pre-chamber shell 42 inner surface 46 into the pre-chamber 44. During each plasma discharge event, the plasma ignition controller 50 operates to generate a high-frequency, high-voltage electrical pulse that is supplied to the electrode 33 via the electrical cable 52. In one example, the high-frequency, high-voltage electrical pulse may have a peak primary voltage of 100 V, secondary voltages between 10 and 70 kV, a duration of 2.5 ms, and a total energy of 1.0 J, with a frequency near one megahertz (MHz). The plasma discharge event generates one or a plurality of plasma discharge streamers that originate at the mounting boss 29 and propagate towards the tip portion 34. The plasma discharge streamers interact with and ignite the cylinder charge, which combusts in the combustion chamber 16 to generate mechanical power. The one or more plasma propagating features 45 serve to propagate the one or a plurality of plasma discharge streamers away from the tip portion 34 throughout the pre-chamber 44. Accordingly, combustion within the pre-chamber is the specific details of the configuration of the plasma igniter 31, its arrangement in the combustion chamber 16, and operating parameters (peak voltage, frequency and duration) associated with electric power and timing of activation during each plasma discharge event are application-specific, and are preferably selected to achieve desired combustion characteristics within the combustion chamber 16. The plurality of plasma discharge streamers generate a large discharge area for effective flame development in cylinder charges that may be stoichiometric homogeneous, lean homogeneous, rich homogeneous, and/or lean/rich stratified and lean controlled auto-ignition in nature.

As illustrated in FIG. 2, the combustion ignition device 30 comprises four plasma propagating features 45 which are shown propagating four respective plasma discharge streamers away from the plasma igniter 31. The number, location, and shape of such plasma propagating features 45 can be selected to optimize the propagation of plasma discharge streamers within the pre-chamber 44. In some embodiments, the plasma propagating features 45 can comprise conical and/or wedge geometries, among others. The plasma propagating features 45 can be biased towards the tip portion 34, so as to direct the propagation of plasma discharge streamers away from residual fuel and/or exhaust that may accumulate proximate the mounting boss 29. The plasma propagating features 45 can comprise roughened surfaces, or prongs and/or grooves to better attract electrons. For example, the plasma propagating features can comprise a surface roughness of up to about 100 μm, up to about 125 μm, or up to about 150 μm. The plasma propagating features can extend inward from the inner surface 46 of the pre-chamber shell 42 by up to about 5 mm, up to about 6 mm, or up to about 7 mm, for example. The plasma propagating features can extend inward from the inner surface 46 of the pre-chamber shell 42 by a distance of up to about 45% of the radius of the pre-chamber 22, up to about 50% of the radius of the pre-chamber 22, or up to about 55% of the radius of the pre-chamber 22, in some embodiments.

The plasma propagating features 45 can comprise conductive metals and metal alloys, such as copper alloys and aluminum alloys, and may particularly comprise refractory metals such as titanium, vanadium, chromium, manganese, zirconium, niobium, molybdenum, technetium, ruthenium, hafnium, tantalum, tungsten, rhenium, osmium, and iridium. The pre-chamber shell can comprise metals and metal alloys, such as copper alloys and aluminum alloys, and may also comprise refractory metals.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A combustion ignition device disposed in a combustion chamber of an internal combustion engine, comprising:
a pre-chamber shell having an inner surface defining a pre-chamber and one or more apertures establishing fluidic communication between the pre-chamber and the combustion chamber;
a barrier-discharge plasma igniter, including a tip portion disposed in the pre-chamber; and
one or more plasma propagating features extending from the pre-chamber shell inner surface into the pre-chamber.

2. The combustion ignition device of claim 1, wherein the one or more plasma propagating features comprise a refractory metal.

3. The combustion ignition device of claim 1, wherein the one or more plasma propagating features comprise a cone or wedge shape.

4. The combustion ignition device of claim 1, wherein the pre-chamber shell comprises a copper alloy, an aluminum alloy, or a refractory metal.

5. The combustion ignition device of claim 1, wherein the barrier-discharge plasma igniter comprises an electrode including a tip portion that is encapsulated in a dielectric material.

6. The combustion ignition device of claim 1, wherein the one or more plasma propagating features are biased towards the tip portion of the barrier-discharge plasma igniter.

7. The combustion ignition device of claim 1, wherein the one or more plasma propagating features comprise a surface roughness of up to about 150 micrometers.

8. The combustion ignition device of claim 1, wherein the one or more plasma propagating features comprise a plurality of plasma propagating features.

9. The combustion ignition device of claim 1, wherein the one or more plasma propagating features extend inward from the inner surface of the pre-chamber shell by up to about 7 millimeters.

10. The combustion ignition device of claim 1, further comprising a pre-chamber fuel injector including a tip portion disposed in the pre-chamber and a pre-chamber air injector including a tip portion disposed in the pre-chamber.

11. An internal combustion engine, comprising:
a cylinder bore, a cylinder head and a piston cooperating to form a combustion chamber;
a fuel injector disposed to inject fuel to the combustion chamber; and
a combustion ignition device disposed in the combustion chamber and including:
a pre-chamber shell having an inner surface defining a pre-chamber and one or more apertures establishing fluidic communication between the pre-chamber and the combustion chamber, and
a barrier-discharge plasma igniter, including a tip portion disposed in the pre-chamber.

12. The internal combustion engine of claim 11, wherein the one or more plasma propagating features comprise a refractory metal.

13. The internal combustion engine of claim 11, wherein the one or more plasma propagating features comprise a cone or wedge shape.

14. The internal combustion engine of claim 11, wherein the pre-chamber shell comprises a copper alloy or an aluminum alloy.

15. The internal combustion engine of claim 11, wherein the barrier-discharge plasma igniter comprises an electrode including a tip portion that is encapsulated in a dielectric material.

16. The internal combustion engine of claim 11, wherein the one or more plasma propagating features are biased towards the tip portion of the barrier-discharge plasma igniter.

17. The internal combustion engine of claim 11, wherein the one or more plasma propagating features comprise a surface roughness of up to about 150 micrometers.

18. The internal combustion engine of claim 11, wherein the one or more plasma propagating features comprise a plurality of plasma propagating features.

19. The internal combustion engine of claim 11, wherein the one or more plasma propagating features extend inward from the inner surface of the pre-chamber shell by up to about 7 millimeters.

20. The internal combustion engine of claim 11, further comprising a pre-chamber fuel injector including a tip portion disposed in the pre-chamber and a pre-chamber air injector including a tip portion disposed in the pre-chamber.
